(19) United States
(12) Patent Application Publication
(10) Pub. No.: US 2014/0315009 A1
(43) Pub. Date: Oct. 23, 2014

(54) RESIN COMPOSITION AND METHOD FOR PRODUCING SAME

(71) Applicant: SUMITOMO BAKELITE CO., LTD., Shinagawa-ku, Tokyo (JP)

(72) Inventors: Miki Noda, Tokyo (JP); Kazunobu Senoo, Tokyo (JP)

(73) Assignee: SUMITOMO BAKELITE CO., LTD., Shinagawa-ku, Tokyo (JP)

(21) Appl. No.: 14/366,065

(22) PCT Filed: Dec. 17, 2012
(86) PCT No.: PCT/JP2012/082676

§ 371 Date: Jun. 17, 2014

(30) Foreign Application Priority Data
Dec. 19, 2011 (JP) 2011-276568
Feb. 10, 2012 (JP) 2012-026811
Mar. 29, 2012 (JP) 2012-075520
Mar. 30, 2012 (JP) 2012-078683

(51) Int. Cl. C08L 71/00; B05D 1/00

(52) U.S. Cl. CPC C08L 71/00; B05D 1/005
USPC 428/220; 524/35; 427/240

(57) ABSTRACT

Provided is a resin composition which is characterized by including nanofibers in a hydrophilic resin or a polyolefin resin, wherein the nanofibers are cellulose nanofibers and the average fiber diameter thereof is 4 to 1000 nm. The X-ray diffraction pattern of the resin composition has an intensity distribution which indicates that a resin crystal is oriented.

### TECHNICAL FIELD

The present invention relates to a resin composition containing: a hydrophilic resin or a polyolefin resin; and nanofibers; a thin film containing the resin composition, and a method for producing the same.

The present invention claims priority on the basis of Japanese Patent Application No. 2011-276568 filed in Japan on Dec. 19, 2011, Japanese Patent Application No. 2012-075520 filed in Japan on Mar. 29, 2012, Japanese Patent Application No. 2012-026811 filed in Japan on Feb. 10, 2012, and Japanese Patent Application No. 2012-078683 filed in Japan on Mar. 30, 2012, the contents of which are incorporated herein by reference.

### BACKGROUND OF THE INVENTION

A gas-barrier property is generally enhanced along with an increase in the crystallinity degree of a resin. The reason therefor is that a gas passes through amorphous parts in a resin, and therefore the increase in the crystallinity degree lengthens the distance the gas travels. In addition, in the case where a resin crystal is oriented, the distance the gas travels becomes longer than in a case where a resin crystal is not oriented, and thereby the gas-barrier property is also enhanced (Nonpatent Document 1).

There are many reports of mechanical strength being increased by filling a resin with nanofibers; or of the orientation of nanofibers itself (Patent Documents 1 and 2).

However, the orientation of a resin crystal caused by filling a resin with nanofibers is not confirmed. In addition, an X-ray diffraction analysis with respect to the orientation of the resin crystal in the resin is not conducted.

In particular, it is generally assumed that a resin is naturally oriented when the resin forms a thin film, but the orientation degree thereof is not sufficient.

### DOCUMENTS OF RELATED ART

### Patent Documents

Patent Document 1: Japanese Unexamined Patent Application Publication (Translation of PCT Application) No. 2003-534955
Patent Document 2: Japanese Unexamined Patent Application Publication No. 2010-216024

### Nonpatent Documents

Nonpatent Document 1: “New Developments in gas barrier, aroma retention packaging material” edited and published by Toray Research Center, Inc. p. 9 (Annual 1999)

### DISCLOSURE OF THE INVENTION

### Problems to be Solved by the Invention

It is aimed to obtain a resin composition in which the mechanical strength is enhanced and the gas-barrier property is improved by filling a resin with nanofibers to orient a resin crystal.

### Means to Solve the Problems

The present invention includes the following aspects.

(1) A resin composition containing: a resin and nanofibers, wherein

the resin is a hydrophilic resin or a polyolefin resin, and

an X-ray diffraction pattern derived from a crystal component of the resin has an intensity distribution in a circumferential direction, when the resin composition is subjected to an X-ray diffraction measurement.

(2) The resin composition according to (1) mentioned above, wherein a filling rate of the nanofibers in the resin composition is 0.5% by weight or more and less than 50% by weight.
(3) The resin composition according to (2) mentioned above, wherein the filling rate of the nanofibers in the resin composition is 0.5% by weight or more and 25% by weight or less.
(4) The resin composition according to any one of (1) to (3) mentioned above, wherein the nanofibers are cellulose nanofibers.
(5) The resin composition according to (4) mentioned above, wherein the cellulose nanofibers have an average fiber diameter of 4 to 1000 nm.
(6) The resin composition according to (5) mentioned above, wherein the cellulose nanofibers are fibers finely pulverized by subjecting a cellulose to chemical treatment and/or mechanical treatment till the average fiber diameter of 4 to 1000 nm is obtained.
(7) The resin composition according to any one of (4) to (6) mentioned above, wherein at least partial hydroxyl groups in a molecule of the cellulose nanofibers are oxidized.
(8) The resin composition according to any one of (4) to (7) mentioned above, wherein the cellulose nanofibers are obtained by treating a natural cellulose in a water solvent with a co-oxidant in a presence of an N-oxyl compound as an oxidation catalyst.
(9) The resin composition according to any one of (1) to (8) mentioned above, wherein the resin is the hydrophilic resin, and the hydrophilic resin is at least one selected from the group consisting of a polyalkylene glycol resin, a polyvinyl alcohol, a polyethylene oxide, a polyethylenimine, derivatives thereof, and copolymers thereof.
(10) The resin composition according to (9) mentioned above, wherein the hydrophilic resin is the polyalkylene glycol resin, and the polyalkylene glycol resin is at least one selected from the group consisting of a polyethylene glycol and a polypropylene glycol.
(11) The resin composition according to any one of (1) to (8) mentioned above, wherein the resin is the polyolefin resin, and the polyolefin resin is a polyolefin resin selected from the group consisting of a high-density polyethylene, a low-density polyethylene, a linear low-density polyethylene, a high-molecular-weight polyethylene, an ultrahigh-molecular-weight polyethylene, an isotactic polypropylene, a syndiotactic polypropylene, a polybutene, derivatives thereof, and copolymers thereof.
(12) A thin film consisting of the resin composition of any one of (1) to (11) mentioned above.
(13) The thin film according to (12) mentioned above, wherein a thickness of the thin film is 300 nm or less.
(14) A method for producing a thin film of (12) or (13) mentioned above, containing a step of forming a film by spin-coating the resin composition of any one of (1) to (11) mentioned above.

### Effects of the Inventions

A resin composition having an enhanced mechanical strength and an improved gas-barrier property is provided by filling a hydrophilic resin or a polyolefin resin with nanofibers to orient a resin crystal.

### BRIEF EXPLANATION OF DRAWINGS

FIG. 1 is a drawing indicating an X-ray diffraction pattern obtained in Example 1.

FIG. 2 is a drawing indicating an X-ray diffraction pattern obtained in Example 2.

FIG. 3 is a drawing indicating an X-ray diffraction pattern obtained in Example 3.

FIG. 4 is a drawing indicating an X-ray diffraction pattern obtained in Example 4.

FIG. 5 is a drawing indicating results of films prepared in Example 1, Example 5, Comparative example 1, and Comparative example 2, and measured at a wavelength of 1.54 Å using a scintillation counter.

FIG. 6 is a drawing indicating an X-ray diffraction pattern obtained in Comparative example 2.

FIG. 7 is a drawing indicating an X-ray diffraction pattern obtained in Comparative example 3.

FIG. 8 is a drawing indicating an X-ray diffraction pattern obtained in Comparative example 4.

FIG. 9: is a drawing indicating an X-ray diffraction pattern obtained in Example 5.

FIG. 10 is a drawing indicating an X-ray diffraction pattern obtained in Example 6.

FIG. 11 is a drawing indicating an X-ray diffraction pattern obtained in Example 8.

FIG. 12 is a drawing indicating an X-ray diffraction pattern obtained in Example 9.

FIG. 13 is a drawing indicating an X-ray diffraction pattern obtained in Example 10.

FIG. 14 is a drawing indicating results of Example 9, Comparative example 5, and Comparative example 6, measured at a wavelength of 1.54 Å using a scintillation counter.

FIG. 15 is a drawing indicating an X-ray diffraction profile obtained in Example 11.

FIG. 16 is a drawing indicating an X-ray diffraction profile obtained in Comparative example 8.

FIG. 17 is a drawing indicating intensity profiles in an azimuthal direction of a (040) plane of isotactic polypropylene crystals prepared in Example 11 and Comparative example 8.

FIG. 18 is a pattern diagram of an X-ray diffraction image.

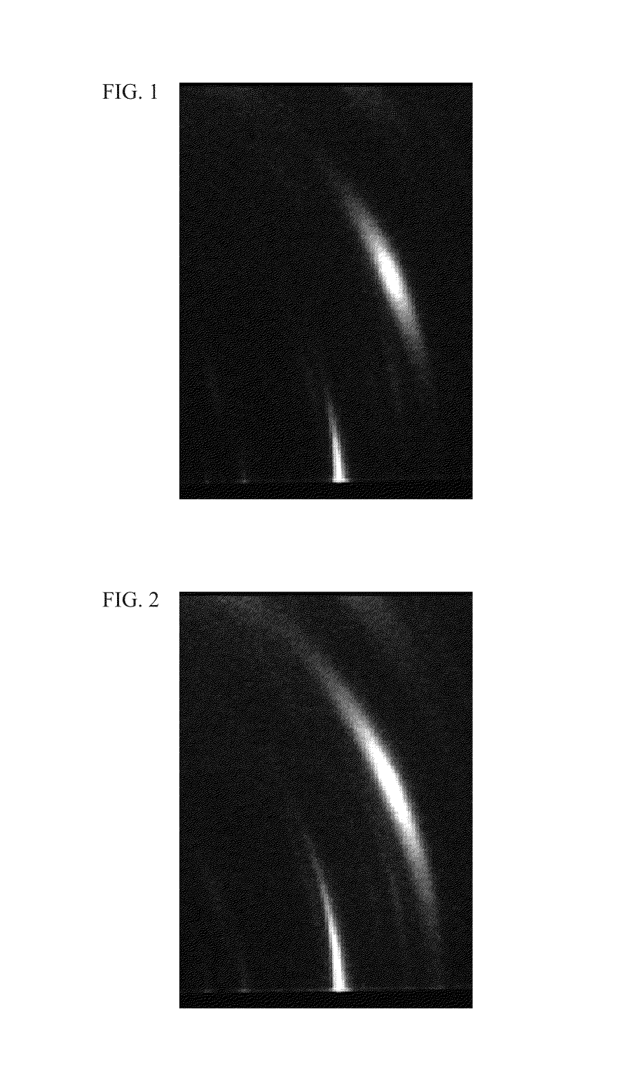

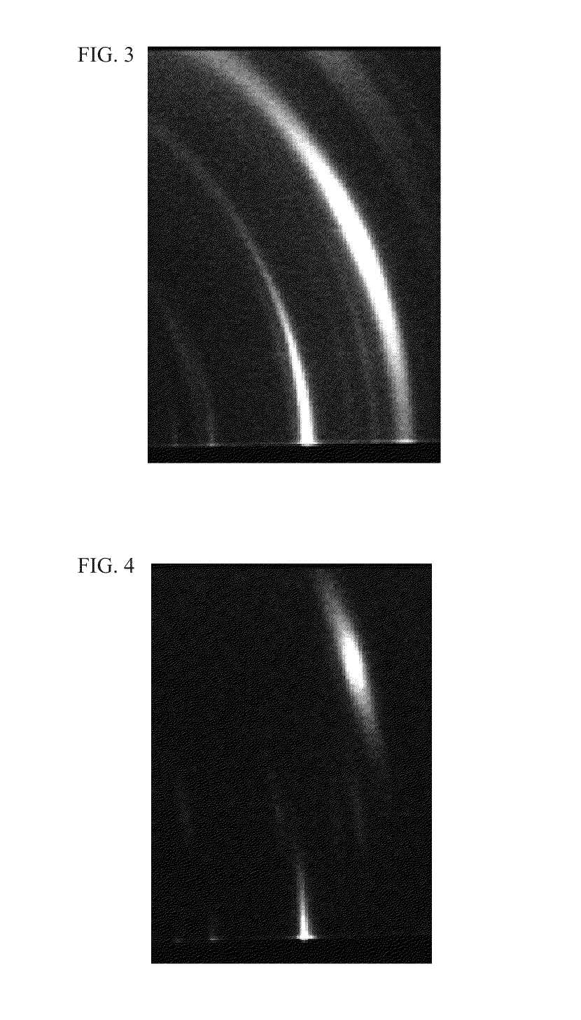

### EMBODIMENTS OF THE INVENTION

The first aspect of the present invention is a resin composition containing nanofibers in a hydrophilic resin or a polyolefin resin, characterized in that an X-ray diffraction pattern derived from a crystal component of the resin has an intensity distribution in a circumferential direction, when the resin composition is subjected to an X-ray diffraction measurement. The phrase “an X-ray diffraction pattern derived from a crystal component of the resin has an intensity distribution in a circumferential direction, when the resin composition is subjected to an X-ray diffraction measurement” means that the crystal component in the resin is oriented by forming a film of the resin composition, when observed from a cross-sectional direction of the film, and preferably means that the orientation degree π thereof, calculated by the following formula (I), is more than 0.34, and satisfies the following formula (II).

$$π = \frac{( 180 - H )}{180} \qquad ( I )$$

In the formula (I), π represents the orientation degree, and H represents a half-value width in a circumferential direction. The half-value width, for example, represents a minimum width of azimuth angles where the diffraction intensity in an azimuth angle—diffraction intensity profile becomes a half value of the maximum value (peak value) in a (120) plane when the resin is a polyalkylene glycol (in a (040) plane when the resin is an isotactic polypropylene). In the case where plural peaks are present within an azimuth angle range from 0° to 180°, H represents the sum of the half-value widths derived from all peaks. The orientation degree it of 1 means the fully-orientated state, and the orientation degree π of 0 means the non-orientated state.

The relation between the orientation degree π and the thickness of the film formed using the resin composition preferably satisfies the following formula.

π>1.5958X^{-0.18} (II)

In the formula (II), π represents the orientation degree, and X represents the film thickness (nm).

The nanofibers available in the present invention are preferably cellulose nanofibers. As the cellulose nanofibers, a regenerated cellulose obtained by finely pulverizing a natural cellulose such as a refined pulp derived from needle-leaved tree or broad-leaved tree, a cellulose derived from cotton linter or cotton lint, a cellulose derived from seaweed such as Valonia or Cladophorales, a cellulose derived from sea squirts, a cellulose produced by bacteria, or the like, is preferably available.

The average fiber diameter of the cellulose nanofibers is preferably 4 to 1000 nm. In the case where the average fiber diameter is less than 4 nm, the preparation of the nanofibers tends to be difficult. On the other hand, in the case where the average fiber diameter is 1000 nm or less, the dispersibility of the resin tends to be favorable, and the gas-barrier properties thereof tends to be improved.

The average fiber diameter is determined as follows. A dispersion containing fibriform fillers in a solid ratio of 0.05% by weight to 0.1% by weight is prepared, and the dispersion is cast-coated or spin-coated on a carbon-coated grid to obtain a sample for TEM (transmission electron microscopy) observation. In the case where fibers having a large fiber diameter are contained, the surface of a sample prepared by cast-coating or spin-coating the dispersion on a glass may be observed using a SEM (scanning electron microscope). The observation of electron microscope images is conducted in a magnification mode of 5000 fold, 10000 fold, or 50000 fold, the magnification mode being selected depending on the size of fibers contained therein. Samples are prepared and conditions for the observation (in terms of magnification mode or the like) are set so that at least 20 fibers intersect with an assumed axis of an arbitrary horizontal or vertical image width in an obtained image. Two vertical and horizontal axes per observation image satisfying the above-mentioned conditions are arbitrary drawn to visually read fiber diameters of fibers intersecting with the axes. Thus, images of non-overlapping surfaces are taken at 3 points or more using an electron microscopy to read fiber diameters of fibers intersecting with two axes (thereby obtaining information with respect to the fiber diameters of at least 20×2×3=120 fibers). The thus obtained data with respect to the fiber diameters is used to calculate the average fiber diameter thereof (number-average fiber diameter thereof).

There are no particular limitations on the method for obtaining the above-mentioned cellulose nanofibers, and conventionally-known chemical treatment methods or mechanical treatment methods may be adopted, and a method in which treatment was repeatedly conducted using an equipment having a component workable to defiberize, such as, a medium-agitation-mill treatment equipment, a vibration-mill treatment equipment, a high-pressure homogenizer treatment equipment, or an ultrahigh-pressure homogenizer treatment equipment, an electrospinning method, a steam-jet method, APEX (trade mark) technique (Polymer Group. Inc.) method, or the like, may be adopted.

It is most preferable from a standpoint of an energy efficiency or the like that fine fibers be prepared using a chemical-treatment method described in Japanese Unexamined Patent Application Publication No. 2008-1728. More specifically, the cellulose nanofibers are preferably obtained by conducting an oxidation process in which a natural cellulose used as a raw material is reacted with a co-oxidant in water in the presence of an N-oxyl compound as an oxidation catalyst to oxidize the natural cellulose, and thereby reactant fibers in which at least partial hydroxyl groups in a molecule of the cellulose nanofibers are oxidized are obtained. The cellulose nanofibers are more preferably obtained by conducting, after the oxidation process, a purification process to obtain resultant fibers immersed in water after impurities thereof are removed, and a dispersion process in which the resultant fibers immersed in water are dispersed in a solvent (details thereof are described in Japanese Unexamined Patent Application Publication No. 2010-270315).

Amounts (mmol/g) of an aldehyde group and a carboxyl group in a cellulose, with respect to the weight of cellulose fibers, are evaluated in the following manner.

The dry weight of a cellulose sample is measured, 60 ml of 0.5 to 1% by weight of a slurry is prepared, and then the pH thereof is adjusted to approximately 2.5 with 0.1 M of a hydrochloric acid aqueous solution, followed by adding dropwise 0.05 M of a sodium hydroxide aqueous solution to measure the electrical conductivity. The measurement is continued until the pH reaches approximately 11. The functional group amount 1 is determined in accordance with the following formula using an amount (V) of sodium hydroxide consumed at a neutralization stage of the weak acid in which the electrical conductivity is mildly changed. The functional group amount 1 represents the amount of the carboxyl group.

Functional group amount (mmol/g)=V (ml)×0.05/mass of cellulose (g)

Next, the cellulose sample is further oxidized for 48 hours at room temperature in a 2% sodium chlorite aqueous solution, the pH of which is adjusted to 4 to 5, and then a functional group amount 2 is measured as described above, again. A functional group amount added by the oxidation (=the functional group amount 2—the functional group amount 1) is calculated to obtain the amount of an aldehyde group.

The following provides an explanation with respect to the resin.

The resin available in the present invention is a hydrophilic resin or a polyolefin resin.

The hydrophilic resin is preferably used as the resin, because a solvent having a high compatibility with cellulose nanofibers is used to be mixed with the cellulose nanofibers to obtain a resin composition.

Although there is no particular limitation on the hydrophilic resin available in the present invention, the hydrophilic resin is preferably selected from the group consisting of a polyalkylene glycol resin, a polyvinyl alcohol, a polyethylene oxide, a polyethylenimine, derivatives thereof, and copolymers thereof.

The hydrophilic resin is preferably the polyalkylene glycol resin. Examples of the polyalkylene glycol resin include polymethylene glycol, polyethylene glycol, polypropylene glycol, polybutene glycol, polypentene glycol, and the like. Among these, at least one selected from the group consisting of polyethylene glycol and polypropylene glycol is preferable, and polyethylene glycol is more preferable.

Although the polyolefin resin available in the present invention is not particularly limited, the polyolefin resin is preferably a polyolefin resin selected from the group consisting of a high-density polyethylene (HDPE), a low-density polyethylene (LDPE), a linear low-density polyethylene (LLDPE), a high-molecular-weight polyethylene (HMW-PE), an ultrahigh-molecular-weight polyethylene (UHMW-PE), an isotactic polypropylene (iPP), a syndiotactic polypropylene (sPP), polybutene, derivatives thereof, and copolymers thereof. Among these, at least one selected from the group consisting of a linear low-density polyethylene and an isotactic polypropylene is preferably used, and an isotactic polypropylene is more preferably used.

In the resin composition according to the present invention, an increase in the amount of the nanofibers increases the orientation of the resin, but the resin tends to be poorly crystallized. On the other hand, a small amount of the nanofibers tends to deteriorate orientation effects.

Although thin-filming of the resin makes it possible to orient the resin, thin-filming by itself does not provide adequate properties.

Accordingly, it is preferable that the cellulose nanofibers be formulated so that the amount ratio thereof, with respect to the total weight of the resin composition, be 0.5% by weight or more and less than 50.0% by weight, and more preferably 0.5% by weight or more and 25.0% by weight or less. In the case where the amount ratio of the cellulose nanofibers is equal to or more than the lower limit described above, the orientation of the resin tends to be improved, whereas in the case where the amount ratio is equal to or less than the upper limit described above, the crystallization of the resin tends to be improved.

The resin composition according to the present invention may be obtained by mixing the components using an arbitrary method. For example, a method in which the resin and the fibriform fillers (cellulose nanofibers) are directly mixed may be adopted. In the method, heating may be conducted during the mixing process, as needed. However, a method in which a dispersion of the fibriform fillers is prepared using a solvent, the dispersion is mixed and stirred with the resin to obtain an uniform dispersion, and then the solvent is removed is preferable, because the method makes it possible to obtain a resin composition having an excellent dispersibility of the fibriform fillers. A method in which a dispersion of the fibriform fillers in a solvent is freeze-dried to form a sheet and then the sheet is immersed in the resin, also makes it possible to obtain a uniform resin composition.

It is preferable that a solvent that can maintain the dispersibility of the fibriform filler be used as the solvent. Although there are no particular limitations on the solvent, examples thereof include methyl alcohol, ethyl alcohol, isopropyl alcohol, ethylene glycol, propylene glycol, diethylene glycol, dioxane, acetone, methyl ethyl ketone, methyl cellosolve, tetrahydrofuran, pentaerythritol, dimethyl sulfoxide, dimethylformamide, N-methyl-2-pyrolidone, and the like. In the case where the hydrophilic resin is used as the resin, water may be used as a solvent. A single solvent or a combination of at least two solvents may be used. The polarizability of an original dispersion medium may be gradually changed to the polarity of a target dispersion medium to disperse the fibriform filler in a dispersion medium having a different polarity.

When the resin composition according to the present invention is made into a film, and then subjected to an X-ray diffraction measurement, an X-ray diffraction pattern derived from a crystal component of the resin has an intensity distribution in a circumferential direction (Φ), and appears as a dot, arc, semicircle, or circle. The phenomenon shows that the resin in the resin composition according to the present invention is oriented.

The X-ray diffraction measurement is conducted, for example, in accordance with a transmission method, or a grazing-incidence X-ray diffraction method (may be referred to as a diagonal-incidence X-ray diffraction method, a small-incidence-angle X-ray diffraction method, or a thin film X-ray diffraction method). The grazing-incidence X-ray diffraction method is a technique in which an X-ray enters at a low angle near a critical angle with respect to the sample surface to detect a diffraction from the sample. The critical angle is an angle at which the incident X-ray results in total reflection, and is specifically an angle near 0°.

The following provides an explanation with respect to measurement conditions.

An X-ray diffraction apparatus is used to conduct measurement. There are no particular limitations on the X-ray diffraction apparatus, and examples thereof include NANO Viewer (Rigaku Corporation), SPring-8 (Japan Synchrotron Radiation Research Institute) BL03XU, and BL19B2. In the case of NANO Viewer, measurement is conducted at a wavelength of 1.54 Å and a camera length of 85.8 mm. PILATUS is used as a two-dimensional detector. Measurement conditions for Spring-8 are set at a measurement wavelength of 1 Å, 1.24 Å, or 1.54 Å, an incidence angle of 0.15°, and a camera length of 63.6 mm. A scintillation counter is used as a zero-dimensional detector, and a flat panel display, imaging plate, IICCD, PILATUS, or PILATUS having a solar slit with a large diameter is used as a two-dimensional detector.

In the case where an X-ray diffraction pattern draws a semicircle or an arc free from intensity distribution in the circumferential direction (Φ), the phenomenon shows that the crystal component of the resin is not oriented. On the other hand, in the case where an X-ray diffraction pattern draws a spot, an arc, a semicircle, or a circle, with an intensity distribution in the circumferential direction (Φ), the phenomenon shows that the crystal component of the resin is oriented (see FIG. 18). Moreover, in the case where a sample is placed so that the film surfaces thereof are placed in the upward/downward directions, and an X-ray is incident from a cross-sectional direction of the sample, the appearance of a diffraction only in the upward/downward directions shows that the diffraction face is placed in parallel to the sample surface, whereas the appearance of a diffraction only in the leftward/rightward directions shows that the diffraction face is placed in a direction perpendicular to the sample surface.

The orientation degree π calculated using the above-mentioned formula (I) is adopted to evaluate orientation. It is preferable that the orientation degree π be more than 0.34 and satisfy the above-mentioned formula (II). The orientation degree π within the above-mentioned range improves the crystallization of a resin component in the resin composition, and enhances the orientation of the crystal component in the resin, and thereby the gas-barrier property of the resultant resin composition is significantly improved.

The second aspect of the present invention is a thin film formed with the resin composition of the first aspect, and explanations with respect to the same constitutions and the like as those of the first aspect are properly omitted. When an X-ray diffraction measurement of the thin film of the aspect is conducted, an X-ray diffraction pattern derived from a crystal component of the resin has an intensity distribution in a circumferential direction (Φ), and appears as a dot, arc, semicircle, or circle, as mentioned in the first aspect. It is preferable that the orientation degree π calculated using the above-mentioned formula (I) be more than 0.34, and satisfy the above-mentioned formula (II).

The film thickness of the thin film is preferably 300 nm or less, and more preferably 20 to 300 nm. In the case where the film thickness is within the above-mentioned range, the orientation of the resin tends to be further increased.

The film thickness may be measured using a micrometer or an ellipsometer, and more specifically using n&k analyzer 1500 (n&k Technology, Inc.). Values having fitting results of at least 99.5% are adopted as measured values, and an average of measured values obtained at 5 different points is calculated as the film thickness.

Examples of a method for forming a thin film using the resin composition of the first aspect include a spin-coating method, a cast-coating method, a LB film-formation method, a dipping method, and a heat-press method.

Among these, the spin-coating method is preferable from the standpoint of control of the film thickness and uniformity of the film thickness. The spin-coating method makes it possible to form a thin film by spin-coating the resin composition onto a substrate, such as a silicon wafer, using a spin coater. The rotational speed and time of the spin coater are arbitrary selected depending on a solvent (dispersion medium) to be used, or the like. In the case where the solvent is water-based (hydrophilic), for example, it is preferable that the rotational speed be 300 to 800 rpm and the rotational time be approximately 5 to 20 minutes.

It is preferable that heating on an oven for approximately 30 to 60 minutes at a temperature higher than a melting point of the resin by approximately 10 to 50° C. be conducted after the thin film is formed, so as to release the stress caused by spin-coating.

In the case where the solvent is water-based, the substrate is preferably hydrophilically treated to make the solvent-development easy. The hydrophilical-treatment for the substrate is preferably a surface-oxidization treatment, and examples thereof include plasma irradiation, corona discharge, immersion in acid or alkali, and exposure to radiation.

### EXAMPLES

Although the present invention will be explained with reference to examples, the technical scope of the present invention is not limited to the examples.

### Preparation Example 1

An undried pulp (mainly composed of fibers having fiber diameters exceeding 1000 nm), in a dry weight of 2 g, 0.025 g of TEMPO (2,2,6,6-tetramethyl-1-piperidine-N-oxyl), and 0.25 g of sodium bromide were dispersed in 150 ml of water, and then 13% by weight of sodium hypochlorite aqueous solution was added thereto in a manner where an amount of sodium hypochlorite with respect to 1 g of the pulp is 2.5 mol, to start a reaction. The pH of the reactant was maintained at 10.5 by adding dropwise 0.5 M of a sodium hydroxide aqueous solution during the reaction. The reaction was considered to be completed when the pH stopped changing. The resultant was neutralized using 0.5M of a hydrochloric acid aqueous solution to the pH of 7, and then filtered with a glass filter, followed by conducting repeatedly 6 times a cycle consisting of washing with an adequate amount of water and filtration, to obtain reactant fibers immersed in water in a solid content of 2% by weight.

Next, water was added to the reactant fibers in a manner where the content of the reactant fibers became 0.2% by weight. The obtained dispersion of the reactant fibers was treated 20 times at a pressure of 20 Mpa using a high-pressure homogenizer (manufactured by Noro-Sobia Ltd., 15 MR-8TA type) to obtain a transparent cellulose nanofiber dispersion.

The dispersion was spin-coated on a hydrophilically-treated silicon wafer substrate (using a spin-coater, manufactured by MIKASA CO., LTD., 1H-360S type), and the resultant was negatively stained using 2% of uranyl acetate for TEM observation. The largest fiber diameter was 10 nm, and the number-average fiber diameter was 6 nm. The resultant was dried to obtain a cellulose in the form of a transparent film, a wide-angle X-ray diffraction pattern of which showed that the cellulose was composed of a cellulose having a type I crystalline structure. In addition, an ATR (Attenuated Total Reflectance) spectral pattern of the same cellulose in the film state showed the presence of a carbonyl group, and amounts of an aldehyde group and a carboxyl group in the cellulose, evaluated as mentioned above, were 0.31 mol/g and 1.7 mmol/g, respectively. In the case where the dispersion was cast-coated on a carbon-coated grid preliminarily hydrophilically-treated, the same results were obtained.

### Example 1

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred at room temperature for 30 minutes. The obtained mixture liquid was spin-coated on a silicon wafer to form a film, and the film was heated on an oven at 100° C. for 30 minutes to release stress caused by spin-coating, and then cooled in the air at room temperature to obtain a thin film having a thickness of 50 nm and containing 1% by weight of cellulose nanofibers. The obtained thin film was observed using a grazing-incidence X-ray diffraction method to obtain an X-ray diffraction pattern of the (120) plane of the polyethylene glycol crystal that had an intensity distribution in a circumferential direction and an orientation degree of 0.82, and the formula (II) was satisfied.

The contributing-rate of the cellulose nanofibers to orient the resin, calculated using the following formula, was 4%.

$$Contributing \text{-} rate ( \% ) = ( \frac{\begin{matrix}Orientation degree \\ of thin film A\end{matrix}}{\begin{matrix}Orientation degree \\ of thin film B\end{matrix}} - 1 ) \times 100$$

In the formula, the thin film A represents the thin film obtained in the present example, and the thin film B represents a thin film different from the thin film A only in a point that the thin film B is free from cellulose nanofibers.

### Example 2

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was spin-coated on a silicon wafer to form a film, and the film was heated on an oven at 100° C. for 30 minutes to release stress caused by spin-coating, and then cooled in the air at room temperature to obtain a thin film having a thickness of 85 nm and containing 1% by weight of cellulose nanofibers. The obtained thin film was observed using a grazing-incidence X-ray diffraction method to obtain an X-ray diffraction pattern of the (120) plane of the polyethylene glycol crystal that had an intensity distribution in a circumferential direction and an orientation degree of 0.74, and the formula (II) was satisfied.

The contributing-rate calculated in the same manner as that of Example 1 was 3%.

### Example 3

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was spin-coated on a silicon wafer to form a film, and the film was heated on an oven at 100° C. for 30 minutes to release stress caused by spin-coating, and then cooled in the air at room temperature to obtain a thin film having a thickness of 233 nm and containing 1% by weight of cellulose nanofibers. The obtained thin film was observed using a grazing-incidence X-ray diffraction method to obtain an X-ray diffraction pattern of the (120) plane of the polyethylene glycol crystal that had an intensity distribution in a circumferential direction and an orientation degree of 0.63, and the formula (II) was satisfied.

The contributing-rate calculated in the same manner as that of Example 1 was 5%.

### Example 4

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was spin-coated on a silicon wafer to form a film, and the film was heated on an oven at 100° C. for 30 minutes to release stress caused by spin-coating, and then cooled in the air at room temperature to obtain a thin film having a thickness of 49 nm and containing 10% by weight of cellulose nanofibers. The obtained thin film was observed using a grazing-incidence X-ray diffraction method to obtain an X-ray diffraction pattern of the (120) plane of the polyethylene glycol crystal that had an intensity distribution in a circumferential direction and an orientation degree of 0.86, and the formula (II) was satisfied.

The contributing-rate calculated in the same manner as that of Example 1 was 9%.

### Example 5

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was spin-coated on a silicon wafer to form a film, and the film was heated on an oven at 100° C. for 30 minutes to release stress caused by spin-coating, and then cooled in the air at room temperature to obtain a thin film having a thickness of 50 nm and containing 5% by weight of cellulose nanofibers. The obtained thin film was observed using a grazing-incidence X-ray diffraction method to obtain an X-ray diffraction pattern of the (120) plane of the polyethylene glycol crystal that had an intensity distribution in a circumferential direction and an orientation degree of 0.82, and the formula (II) was satisfied.

The contributing-rate calculated in the same manner as that of Example 1 was 4%.

### Example 6

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was spin-coated on a silicon wafer to form a film, and the film was heated on an oven at 100° C. for 30 minutes to release stress caused by spin-coating, and then cooled in the air at room temperature to obtain a thin film having a thickness of 39 nm and containing 25% by weight of cellulose nanofibers. The obtained thin film was observed using a grazing-incidence X-ray diffraction method to obtain an X-ray diffraction pattern of the (120) plane of the polyethylene glycol crystal that had an intensity distribution in a circumferential direction and an orientation degree of 0.83, and the formula (II) was satisfied.

The contributing-rate calculated in the same manner as that of Example 1 was 1%.

### Comparative Example 1

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was spin-coated on a silicon wafer to form a film, and the film was heated on an oven at 100° C. for 30 minutes to release stress caused by spin-coating, and then cooled in the air at room temperature to obtain a thin film having a thickness of 90 nm and containing 50% by weight of cellulose nanofibers. No X-ray diffraction pattern derived from a polyethylene glycol crystal in the obtained thin film was observed, which confirmed the amorphous state thereof, and therefore the orientation degrees could not be calculated.

### Comparative Example 2

An aqueous solution of polyethylene glycol (manufactured by Wako Pure Chemical Industries, Ltd., with an average molecular weight of 500000) was spin-coated on a silicon wafer to form a film, and the film was heated in an oven at 100° C. for 30 minutes to release stress caused by spin-coating, and then cooled in the air at room temperature to obtain a thin film having a thickness of 53 nm. The obtained thin film was observed using a grazing-incidence X-ray diffraction method to obtain an X-ray diffraction pattern of the (120) plane of the polyethylene glycol crystal that had an orientation degree of 0.78 but did not satisfy the formula (II) mentioned above.

### Comparative Example 3

An aqueous solution of polyethylene glycol (manufactured by Wako Pure Chemical Industries, Ltd., with an average molecular weight of 500000) was spin-coated on a silicon wafer to form a film, and the film was heated on an oven at 100° C. for 30 minutes to release stress caused by spin-coating, and then cooled in the air at room temperature to obtain a thin film having a thickness of 87 nm. The obtained thin film was observed using a grazing-incidence X-ray diffraction method to obtain an X-ray diffraction pattern of the (120) plane of the polyethylene glycol crystal that had an orientation degree of 0.71 but did not satisfy the formula (II) mentioned above.

### Comparative Example 4

An aqueous solution of polyethylene glycol (manufactured by Wako Pure Chemical Industries, Ltd., with an average molecular weight of 500000) was spin-coated on a silicon wafer to form a film, and the film was heated on an oven at 100° C. for 30 minutes to release stress caused by spin-coating, and then cooled in the air at room temperature to obtain a thin film having a thickness of 270 nm. The obtained thin film was observed using a grazing-incidence X-ray diffraction method to obtain an X-ray diffraction pattern of the (120) plane of the polyethylene glycol crystal that had an orientation degree of 0.58 but did not satisfy the formula (II) mentioned above.

TABLE 1

| | | | | Orientation |
|---|---|---|---|---|
| | Molecular | Content | | degree of |
| | weight of | of | Film | polyethylene |
| | polyethylene | cellulose | thickness | glycol |
| | glycol | nanofiber | (nm) | crystal |
| Example 1 | 500,000 | 1 wt % | 50 | 0.82 |
| Example 2 | 500,000 | 1 wt % | 85 | 0.74 |
| Example 3 | 500,000 | 1 wt % | 233 | 0.63 |
| Example 4 | 500,000 | 10 wt % | 49 | 0.86 |
| Example 5 | 500,000 | 5 wt % | 50 | 0.82 |
| Example 6 | 500,000 | 25 wt % | 39 | 0.83 |
| Comparative | 500,000 | 0 wt % | 53 | 0.78 |
| Example 2 | | | | |
| Comparative | 500,000 | 0 wt % | 87 | 0.71 |
| Example 3 | | | | |
| Comparative | 500,000 | 0 wt % | 270 | 0.58 |
| Example 4 | | | | |

### Example 7

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was poured into a petri dish preliminary subjected to release treatment, and then left on an oven at 50° C. until no liquid remained therein, followed by further drying in a vacuum oven at 120° C. to obtain a transparent film containing 25% by weight of cellulose nanofibers and having a thickness of 43 μm. An X-ray diffraction pattern of the (120) plane of the polyethylene glycol crystal observed from a cross sectional direction of the obtained film had an intensity distribution in a circumferential direction and an orientation degree of 0.933, and the formula (II) was satisfied.

### Example 8

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was poured into a petri dish preliminary subjected to release treatment, and then left on an oven at 50° C. until no liquid remained therein, followed by further drying in a vacuum oven at 120° C. to obtain a transparent film containing 10% by weight of cellulose nanofibers and having a thickness of 78 μm. An X-ray diffraction pattern of the (120) plane of the polyethylene glycol crystal observed from a cross sectional direction of the obtained film had an intensity distribution in a circumferential direction and an orientation degree of 0.932, and the formula (II) was satisfied.

### Example 9

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was poured into a petri dish preliminary subjected to release treatment, and then left on an oven at 50° C. until no liquid remained therein, followed by further drying in a vacuum oven at 120° C. to obtain a transparent film containing 5% by weight of cellulose nanofibers and having a thickness of 61 μm. An X-ray diffraction pattern of the (120) plane of the polyethylene glycol crystal observed from a cross sectional direction of the obtained film had an intensity distribution in a circumferential direction and an orientation degree of 0.906, and the formula (II) was satisfied.

### Example 10

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was poured into a petri dish preliminary subjected to release treatment, and then left on an oven at 50° C. until no liquid remained therein, followed by further drying in a vacuum oven at 120° C. to obtain a transparent film containing 2% by weight of cellulose nanofibers and having a thickness of 160 μm. An X-ray diffraction pattern of the (120) plane of the polyethylene glycol crystal observed from a cross sectional direction of the obtained film had an intensity distribution in a circumferential direction and an orientation degree of 0.906, and the formula (II) was satisfied.

### Comparative Example 5

The cellulose nanofiber dispersion prepared in Preparation Example 1 with a solid content of 0.2% and polyethylene glycol (manufactured by Wako Pure Chemical Industries, Ltd., with an average molecular weight of 500000) were mixed and stirred for 30 minutes at room temperature. The obtained mixture liquid was poured into a petri dish preliminary subjected to release treatment, and then left on an oven at 50° C. until no liquid remained therein, followed by further drying in a vacuum oven at 120° C. to obtain a transparent film containing 75% by weight of cellulose nanofibers and having a thickness of 43 μm. An X-ray diffraction pattern derived from the polyethylene glycol crystal of the obtained film was not observed, which indicated an amorphous state, and therefore the orientation degree could not be determined.

### Comparative Example 6

The cellulose nanofiber dispersion prepared in Preparation Example 1 with a solid content of 0.2% and polyethylene glycol (manufactured by Wako Pure Chemical Industries, Ltd., with an average molecular weight of 500,000) were mixed and stirred for 30 minutes at room temperature. The obtained mixture liquid was poured into a petri dish preliminary subjected to release treatment, and then left on an oven at 50° C. until no liquid remained therein, followed by further drying in a vacuum oven at 120° C. to obtain a transparent film containing 50% by weight of cellulose nanofibers and having a thickness of 43 μm. An X-ray diffraction pattern derived from the polyethylene glycol crystal of the obtained film was not observed, which indicated an amorphous state, and therefore the orientation degree could not be determined.

### Comparative Example 7

A aqueous solution of polyethylene glycol (manufactured by Wako Pure Chemical Industries, Ltd., with an average molecular weight of 500000) was poured into a petri dish preliminary subjected to release treatment, and then left on an oven at 50° C. until no liquid remained therein, followed by further drying in a vacuum oven at 120° C. to obtain a transparent film having a thickness of 50 μm. An X-ray diffraction pattern of the (120) plane of the polyethylene glycol crystal observed from a cross sectional direction of the obtained film did not have an intensity distribution in a circumferential direction, and the orientation degree was 0.

TABLE 2

| | Molecular | | | Orientation | |
|---|---|---|---|---|---|
| | weight of | Amount of | | degree of | |
| | polyethylene | cellulose | | polyethylene | |
| | glycol | nanofibers | Film thickness (m) | glycol crystal | Transparency |
| Example 7 | 500,000 | 25 wt % | 43 | 0.933 | Transparent |
| Example 8 | 500,000 | 10 wt % | 78 | 0.932 | Transparent |
| Example 9 | 500,000 | 5 wt % | 61 | 0.906 | Transparent |
| Example 10 | 500,000 | 2 wt % | 160 | 0.906 | Transparent |

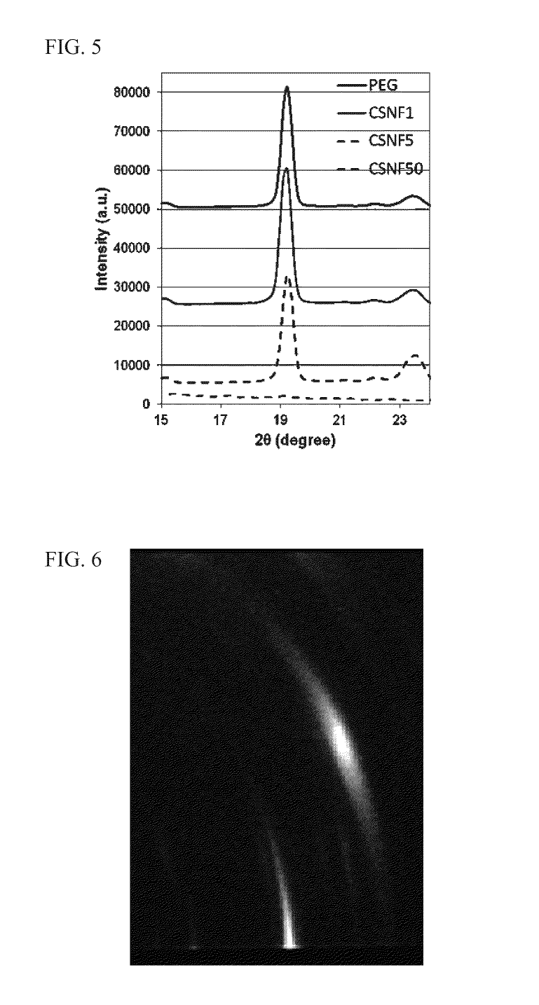

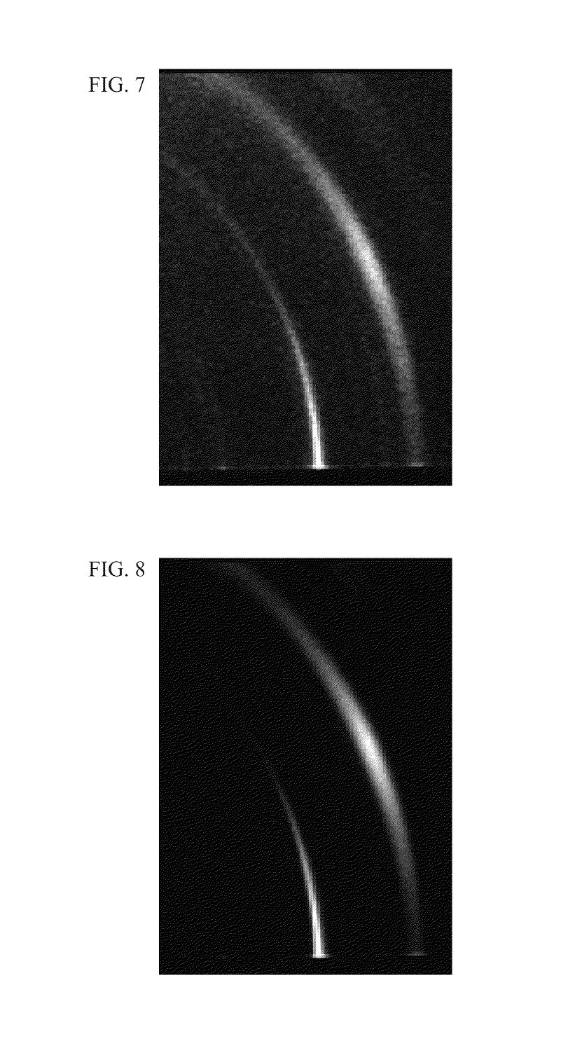

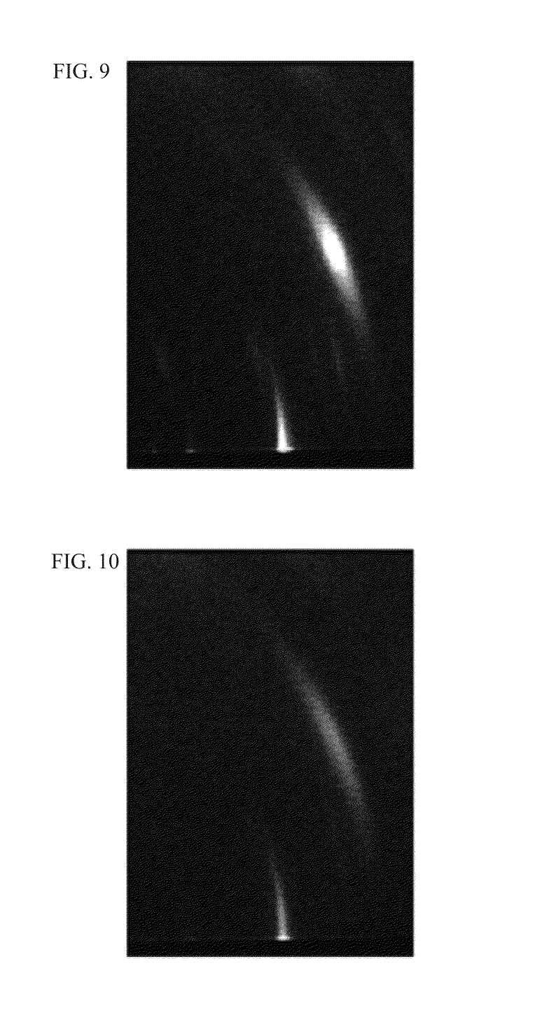

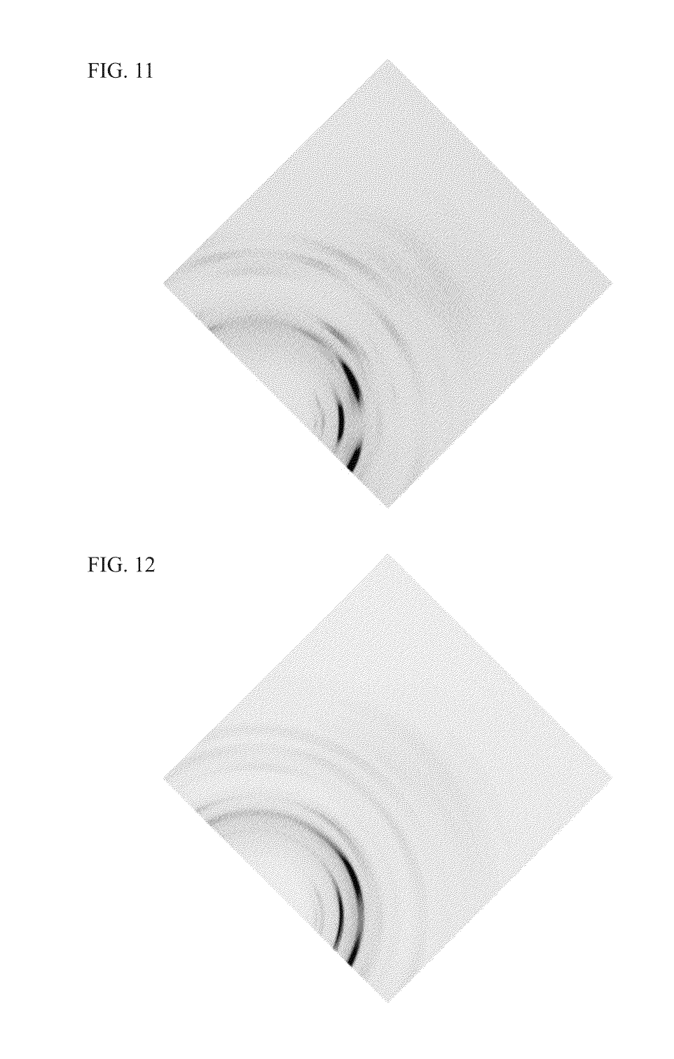

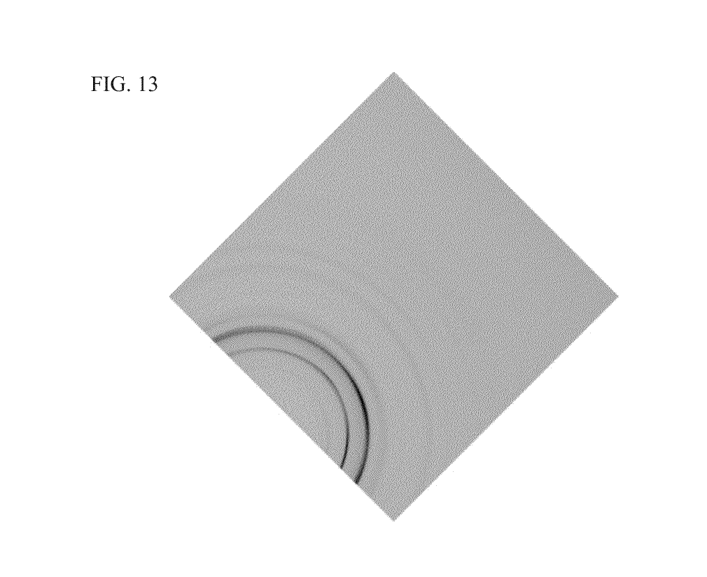

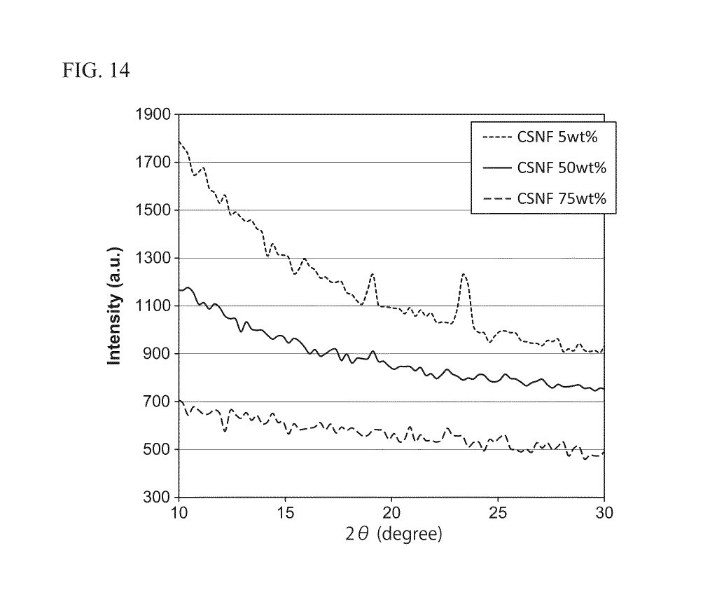

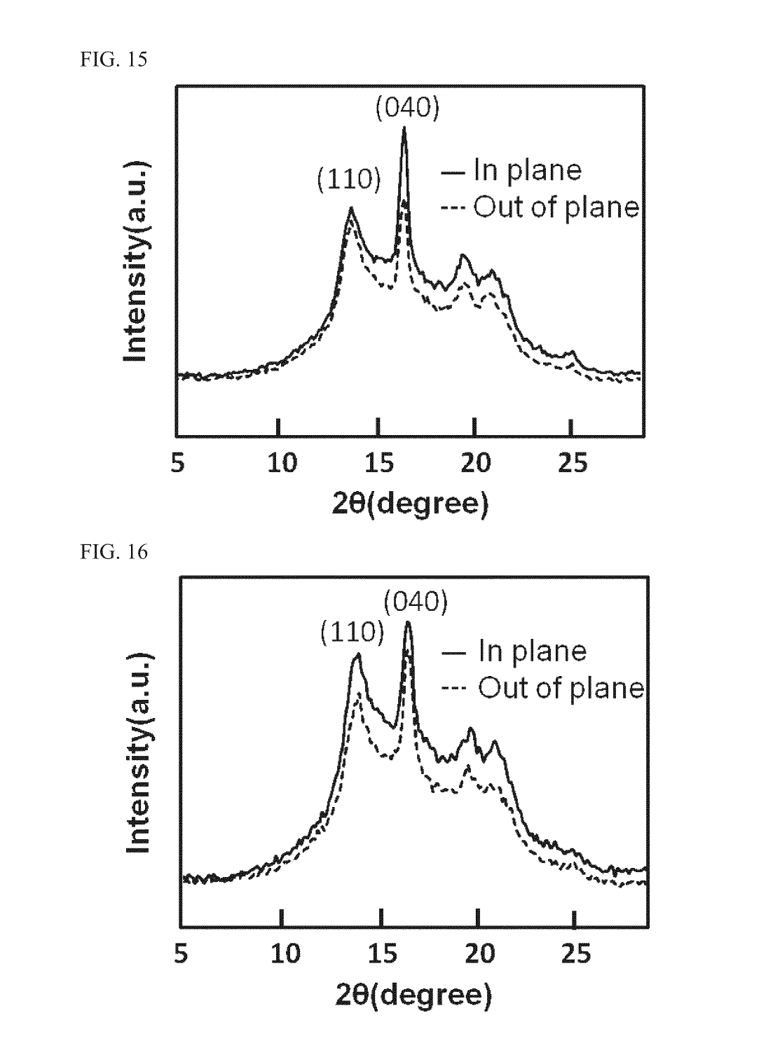

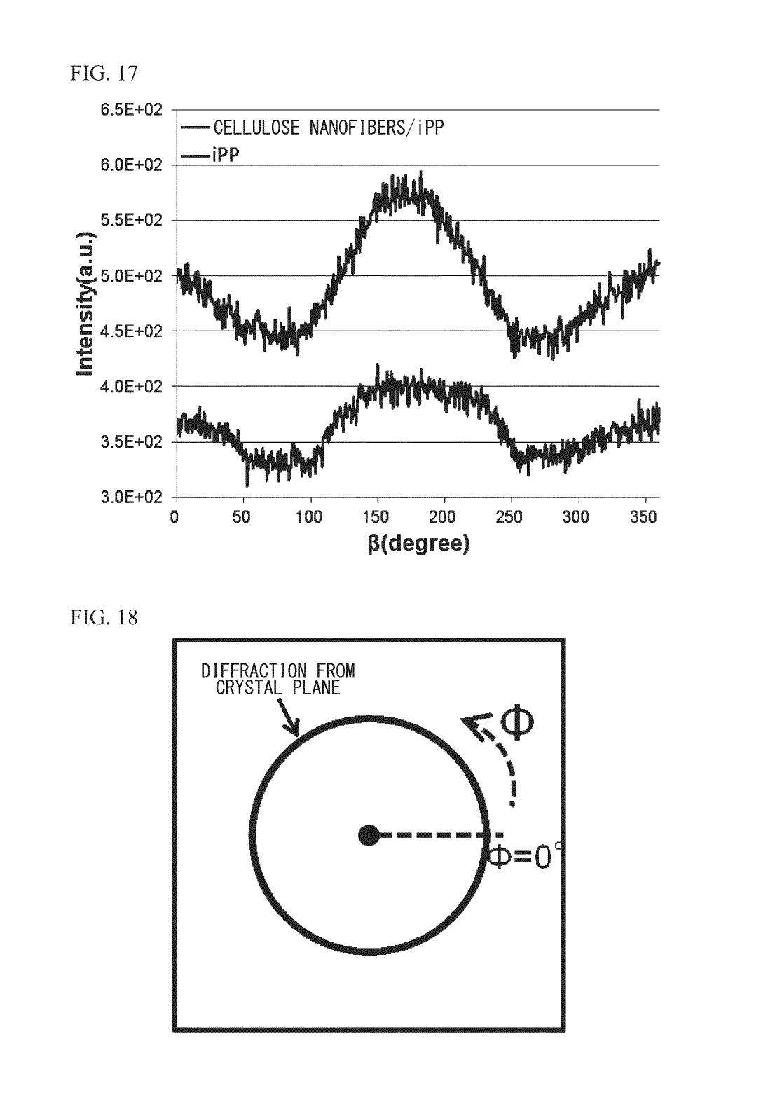

FIG. 5 shows results obtained by measuring films, prepared in Example 1, Example 5, Comparative Example 1, and Comparative Example 2, using a scintillation counter at a measurement wave length of 1.54 Å. In the same manner, FIG. 14 shows results obtained by measuring films, prepared in Example 9, Comparative Example 5, and Comparative Example 6, using a scintillation counter at a measurement wave length of 1.54 Å. The results show that in the case where the amount of CSNF (cellulose nanofibers) was 50% by weight or more, no peak derived from PEG crystal was observed, which indicated that the polyethylene glycol was in an amorphous state.

### Test Example 1

The oxygen transmission rates of the films, prepared in Example 8, Example 9, and Comparative Example 7, were measured in accordance with JIS K7126 B using an oxygen transmission rate measurement apparatus (manufactured by MOCON, under the name of OX-TRAN 2/21 ML) under a constant temperature and humidity condition in which the temperature was 25° C. and the humidity was 65%. The film thickness was determined as an average of values measured at 10 points, different from each other, within a measurement area (diameter of which was 2.5 cm). An evaluation value for gas-barrier properties was calculated using the following formula (see the following Table 3).

$$Evaluation value ( cc \text{/} {m}^{2} \text{/} day ) = Oxygen transmission rates ( cc \text{/} {m}^{2} \text{/} day ) \times ( \frac{\begin{matrix}Film thickness \\ ( μ m )\end{matrix}}{50 ( μ m )} )$$

TABLE 3

| | | | Comparative |
|---|---|---|---|
| | Example 8 | Example 9 | Example 7 |
| Evaluation | 64 | 234 | >344 |
| value | | | |

The film prepared in Comparative Example 7 exceeded the detection limit (344 cc/m²/day) and was poor in the gas-barrier properties. On the other hand, the films prepared in Examples 8 and 9 were significantly excellent in the gas-barrier properties.

### Preparation Example 2

The cellulose nanofiber dispersion prepared in the same manner as that of Preparation Example 1 was dried to obtain a transparent cellulose nanofiber sheet. Water was added to the cellulose nanofiber sheet, and then left still for 10 minutes to swell the cellulose nanofiber sheet. An extra water was removed therefrom, and 50% by volume of an ethanol aqueous solution was added thereto, and then left still for 10 minutes. The same procedures were repeatedly performed except that 70, 80, 90, and 100% by volume of ethanol aqueous solutions were used, respectively. A sequential process consisting of removing an extra 100% by volume of ethanol, adding butanol, and then leaving still for 15 minutes, was performed 4 times to replace ethanol with butanol. Extra butanol was removed until a little amount of butanol remained in a container, and then left still in a freezer for 2 hours. Thereafter, the resultant was freeze-dried in a freeze dryer (manufactured by TOKYO RIKAKIKAI CO., LTD., FDU-1200) to obtain a freeze-dried cellulose nanofiber sheet.

### Example 11

An xylene solution of isotactic polypropylene (manufactured by Prime Polymer Co., Ltd., J106G) was added drowpise to the freeze-dried cellulose nanofiber sheet obtained in Preparation Example 2, and then defoaming and immersion of the resin were conducted under a reduced pressure, followed by removing the solvent on a hot plate at 130° C. The obtained film was sandwiched between glass plates, insides of the glass plates being labeled with release PET films, and then a weight was put thereon, followed by heating at 180° C. for 30 minutes to melt the isotactic polypropylene. Thereafter, the resultant was heated at 120° C. for 3 hours to obtain a cellulose nanofiber composite film. The amount of the cellulose nanofibers in the obtained film was 21.1% by weight, and the film thickness thereof was 182 μm. The X-ray diffraction pattern of the (040) plane of the isotactic polypropylene crystal observed from a cross-sectional direction of the obtained film had an intensity distribution in a circumferential direction, and the orientation degree thereof was 0.46, and the above-mentioned formula (II) was satisfied.

### Comparative Example 8

An xylene solution of isotactic polypropylene (manufactured by Prime Polymer Co., Ltd., J106G) was put in a glass petri dish, and then placed on a hot plate at 130° C. to remove the solvent. The obtained film was sandwiched between a glass plate, inside of which was labeled with a release PET film, and a spacer, and then a weight was put thereon, followed by heating at 180° C. for 30 minutes to melt the isotactic polypropylene. Thereafter, the resultant was heated at 120° C. for 3 hours to obtain an isotactic polypropylene film. The thickness of the obtained film was 153 μM. The X-ray diffraction pattern of the (040) plane of the isotactic polypropylene crystal observed from a cross-sectional direction of the obtained film was obtained, but the orientation degree of the resin was 0.34.

The results of Example 11 and Comparative Example 8 revealed that the addition of cellulose nanofibers improved the orientation degree of the isotactic polypropylene resin by 27%, and thereby the mechanical strength was increased, and the gas-barrier properties were improved.

### INDUSTRIAL APPLICABILITY

A resin composition having an increased mechanical strength and an improved gas-barrier property was provided by filling a hydrophilic resin or a polyolefin resin with nanofibers to orient crystals of the resin. The resin composition may be preferably used in an optical film, or a packing material.

1. A resin composition comprising a resin and nanofibers, wherein
the resin is a hydrophilic resin or a polyolefin resin, and
an X-ray diffraction pattern derived from a crystal component of the resin has an intensity distribution in a circumferential direction, when the resin composition is subjected to an X-ray diffraction measurement.

2. The resin composition according to claim 1, wherein a filling rate of the nanofibers in the resin composition is 0.5% by weight or more and less than 50% by weight.

3. The resin composition according to claim 2, wherein the filling rate of the nanofibers in the resin composition is 0.5% by weight or more and 25% by weight or less.

4. The resin composition according to claim 1, wherein the nanofibers are cellulose nanofibers.

5. The resin composition according to claim 4, wherein the cellulose nanofibers have an average fiber diameter of 4 to 1000 nm.

6. The resin composition according to claim 5, wherein the cellulose nanofibers are fibers finely pulverized by subjecting a cellulose to at least one of a chemical treatment and a mechanical treatment until the average fiber diameter of 4 to 1000 nm is obtained.

7. The resin composition according to claim 4, wherein at least partial hydroxyl groups in a molecule of the cellulose nanofibers are oxidized.

8. The resin composition according to claim 4, wherein the cellulose nanofibers are obtained by treating a natural cellulose in a water solvent with a co-oxidant in a presence of an N-oxyl compound as an oxidation catalyst.

9. The resin composition according to claim 1, wherein the resin is the hydrophilic resin, and the hydrophilic resin is at least one selected from the group consisting of a polyalkylene glycol resin, a polyvinyl alcohol, a polyethylene oxide, a polyethylenimine, derivatives thereof, and copolymers thereof.

10. The resin composition according to claim 9, wherein the hydrophilic resin is the polyalkylene glycol resin, and the polyalkylene glycol resin is at least one selected from the group consisting of a polyethylene glycol and a polypropylene glycol.

11. The resin composition according to claim 1, wherein the resin is the polyolefin resin, and the polyolefin resin is a polyolefin resin selected from the group consisting of a high-density polyethylene, a low-density polyethylene, a linear low-density polyethylene, a high-molecular-weight polyethylene, an ultrahigh-molecular-weight polyethylene, an isotactic polypropylene, a syndiotactic polypropylene, a polybutene, derivatives thereof, and copolymers thereof.

12. A thin film consisting of a resin composition of claim 1.

13. The thin film according to claim 12, wherein a thickness of the thin film is 300 nm or less.

14. A method for producing a thin film consisting of a resin composition comprising a resin and nanofibers, wherein the resin is a hydrophilic resin or a polyolefin resin, and an X-ray diffraction pattern derived from a crystal component of the resin has an intensity distribution in a circumferential direction, when the resin composition is subjected to an X-ray diffraction measurement, comprising a step of forming a film by spin-coating the resin composition.
